(19) United States
(12) Patent Application Publication
(10) Pub. No.: US 2017/0218622 A1
(43) Pub. Date: Aug. 3, 2017

(54) PRECAST HOLLOW BLOCK WALL SYSTEM AND FORMS FOR MANUFACTURING THE SAME

(71) Applicant: Redi-Rock International, LLC, Charlevoix, MI (US)

(72) Inventors: Jacob Manthei, Charlevoix, MI (US); Lance Hadfield, Charlevoix, MI (US)

(21) Appl. No.: 15/411,515

(22) Filed: Jan. 20, 2017

Related U.S. Application Data
(60) Provisional application No. 62/288,712, filed on Jan. 29, 2016.
(60) Provisional application No. 62/431,934, filed on Dec. 9, 2016.

(51) Int. Cl. E04B 2/42; E04B 2/54; B28B 7/28; E02D 29/02; B28B 7/00; B28B 7/18; E04C 1/39; E04B 1/04

(52) U.S. Cl. CPC E04B 2/42; E04C 1/39; E04B 2/54; E04B 1/04; E02D 29/0266; B28B 7/007; B28B 7/183; B28B 7/28; B28B 7/002; E04B 2103/02; E02D 2250/0023; E02D 2250/0007; E02D 2300/0034

(57) ABSTRACT

What is provided is a precast hollow block, a precast wall system incorporating the precast hollow block, and forms for manufacturing a hollow block and a coping cap. Accordingly, the precast hollow block and its incorporation into a precast wall system provide solutions to current “level up” block coping techniques, wall flood protection, wall force protection, and the like. Instead of having mismatched or missing face textures on sloped portions of the wall, the precast wall system allows for easier installation of face-textured blocks directly at the top of the wall. As a result, the precast wall system may readily account for slope transitions of a wall, conform to specific Department of Transportation project requirements, accommodate existing wall construction specifications, and be easily customizable for a variety of applications.

### PRIORITY CLAIM

This patent application is a Non-Provisional patent application and claims priority under 35 U.S.C. 119(e) to U.S. Provisional Patent Application Ser. No. 62/288,712, titled “PRECAST BLOCK COPING SYSTEM AND FORM FOR MANUFACTURING THE SAME,” filed Jan. 29, 2016; and U.S. Provisional Patent Application Ser. No. 62/431,934, titled “PRECAST BLOCK COPING SYSTEM AND FORM FOR MANUFACTURING THE SAME,” filed Dec. 9, 2016. The entire disclosures of the aforementioned patent applications are incorporated by reference as if fully stated herein.

### FIELD

This patent application generally relates to a precast hollow block, incorporation of the precast hollow block into a wall for a variety of applications, and forms for manufacturing the same.

### BACKGROUND

During the construction of a wall, it is generally accepted that a leveling course of concrete is added to the wall prior to setting the precast elements, such as a hollow core block. Coping is commonly used to add a protective cap and to provide a smooth finish to the top of a wall. Coping can be cast-in-place or precast using various elements. A strip of a cast-in-place concrete “level up” is incorporated on the top of a wall to provide a smooth, level surface for the coping. Prior methods that have combined cast-in-place coping on the top of a wall formed by precast elements have been expensive, very time-consuming, and difficult to implement. In particular, some of these methods have resulted in face textures that are either mismatched or entirely absent from sloped portions of finished walls. As such, it is very difficult and time-consuming to install a block that has been cut down to height of only a few inches into a specific location on the wall.

Typically, wall designers refrain from frequently transitioning the slope from one course to another in a wall and, in particular, from transitioning the courses of the wall in a “stair-step” configuration. In addition to purely aesthetic reasons for not using a “stair-step” configuration, designers are often concerned with specific design limitations, such as matching a road grade or meeting stringent Department of Transportation regulations with regard to stepped elevation changes for surfaces located on top of walls. As a result, it is often necessary to ensure specially shaped coping along the top of these walls.

Therefore, it is apparent that there is a need for a better precast hollow block that, among other things, can provide a more efficient and cost-effective precast block coping system. Specifically, the precast block coping system should readily account for transitions in the slopes of a wall from one course to another, conform to state and federal Department of Transportation regulations, accommodate existing wall construction specifications, and be readily customizable for a variety of applications in the field.

### SUMMARY

What is provided is a precast hollow block, a precast wall system incorporating the precast hollow block, and forms for manufacturing a hollow block and a coping cap. In exemplary embodiments, the precast hollow block comprises a top; a bottom; a front side including a front surface, the front side opposed from a back side including a back surface, each of the front surface and the back surface having a textured surface for imparting a natural stone appearance; and a first connecting rib extending laterally from the front side to the back side and a second connecting rib parallel to the first connecting rib and extending laterally from the front side to the back side to form a hollow interior space configured for accepting a filling material, wherein the distance from the first connecting rib to the center of the hollow block is shorter than the distance from the second connecting rib to the center of the hollow block.

During the construction of walls, the precast hollow block may be precast at the correct slope or cut in the field and incorporated within a precast hollow block system. The precast hollow block system may be used for a variety of applications, including coping, flood prevention, and force protection.

In exemplary embodiments, a precast wall system comprises a precast wall system comprising a first set of a plurality of hollow blocks, each of the hollow blocks in the first set comprising a top; a bottom; a front side including a front surface, the front side opposed from a back side including a back surface, each of the front surface and the back surface having a textured surface; and a first connecting rib extending laterally from the front side to the back side and a second connecting rib parallel to the first connecting rib and extending laterally from the front side to the back side to form a hollow interior space configured for accepting a filling material, wherein the first connecting rib is positioned approximately at the center of the hollow block; a second set of a plurality of hollow blocks, wherein the first set of the plurality of hollow blocks is attached to the top of the second set of hollow blocks, each of the hollow blocks in the second set comprising: a top; a bottom; a front side including a front surface, the front side opposed from a back side including a back surface, each of the front surface and the back surface having a textured surface; and a first connecting rib extending laterally from the front side to the back side and a second connecting rib parallel to the first connecting rib and extending laterally from the front side to the back side to form a hollow interior space configured for accepting a filling material, wherein the first connecting rib is positioned approximately at the center of the hollow block; and a plurality of stacked rows of retaining blocks, wherein the second set of hollow blocks is attached to the top of the stacked rows of retaining blocks.

The precast hollow block may be produced in a form using the same dimensions as existing hollow blocks and from existing standard or custom face texture molds. In exemplary embodiments, a form for manufacturing the hollow block comprises a plurality of doors, wherein at least two of the plurality of doors clamp together to form a hollow interior space configured for accepting a filling material; and a base comprising a plurality of face molds configured for insertion of at least one core insert into the form, wherein the core insert is configured for imparting a shape to the hollow block. In some embodiments, a scoring feature may be precast in the hollow blocks at desired positions using a scoring insert. The scoring insert comprises magnets for positioning the scoring insert inside the form.

In exemplary embodiments, the form for manufacturing a coping cap comprises a plurality of doors, wherein each of the plurality of doors slide on rails attached to the coping cap form; and a base comprising a plurality of texture molds configured for insertion of at least one removable insert into the form, wherein the removable insert is configured for imparting a shape to the coping cap.

Accordingly, the precast hollow block and its incorporation into a precast wall system provide solutions to current “level up” block coping techniques, wall flood protection, wall force protection, and the like. Instead of having mismatched or missing face textures on sloped portions of the wall, the precast wall system allows for easier installation of face-textured blocks directly at the top of the wall. As a result, the precast wall system may readily account for slope transitions of a wall, conform to specific Department of Transportation project requirements, accommodate existing wall construction specifications, and be easily customizable for a variety of applications.

### BRIEF DESCRIPTION OF THE DRAWINGS

FIG. 1A is a side perspective view of an exemplary precast hollow block having a height of about 18 inches;

FIG. 1B is a top perspective view of the hollow block of FIG. 1A;

FIG. 1C is a bottom perspective view of the hollow block of FIG. 1A;

FIG. 2 is a side perspective view of an exemplary precast hollow block having a height of about 36 inches;

FIG. 3 is a side perspective view of the exemplary precast hollow block of FIG. 2 comprising a scoring feature;

FIG. 4 is a top view of a scoring insert for creating the scoring feature on the hollow block shown in FIG. 3;

FIG. 5 is a perspective view of an exemplary precast coping block having a height of about 12 inches;

FIG. 6 is a perspective view of an exemplary precast coping block having a height of about 24 inches;

FIG. 7 is a perspective view of an exemplary wall comprising a coping cap affixed along the top of the wall;

FIG. 8 is a perspective view of an exemplary wall comprising a coping cap with an integrated traffic barrier and cast-in-place moment slab affixed along the top of the wall;

FIG. 9 is a perspective view of an exemplary form for manufacturing a hollow block having a height of about 18 inches;

FIG. 10 is a perspective view of an exemplary form for manufacturing a hollow block having a height of about 36 inches;

FIG. 11 is a perspective view of a scoring insert implemented on the exemplary form disclosed in FIG. 10;

FIG. 12 is a perspective view of an exemplary wall comprising a textured hollow block having a height of about 36 inches;

FIG. 13 is a hollow block having about half the length as the hollow block depicted in FIGS. 1A-1C;

FIG. 14A is a perspective view of an exemplary coping form for manufacturing a coping cap in its open orientation;

FIG. 14B is a perspective view of an exemplary coping form for manufacturing the coping cap of FIG. 14A in its closed orientation; and

FIG. 15 is a hollow block having about half the length as the hollow block depicted in FIG. 2.

### DETAILED DESCRIPTION

In the following detailed description, numerous specific details are set forth in order to provide a thorough understanding of the examples as defined in the claimed subject matter, and as an example of how to make and use the examples described herein. However, it will be understood by those skilled in the art that claimed subject matter is not intended to be limited to such specific details, and may even be practiced without requiring such specific details. In other instances, well-known methods, procedures, and ingredients have not been described in detail so as not to obscure the invention defined by the claimed subject matter.

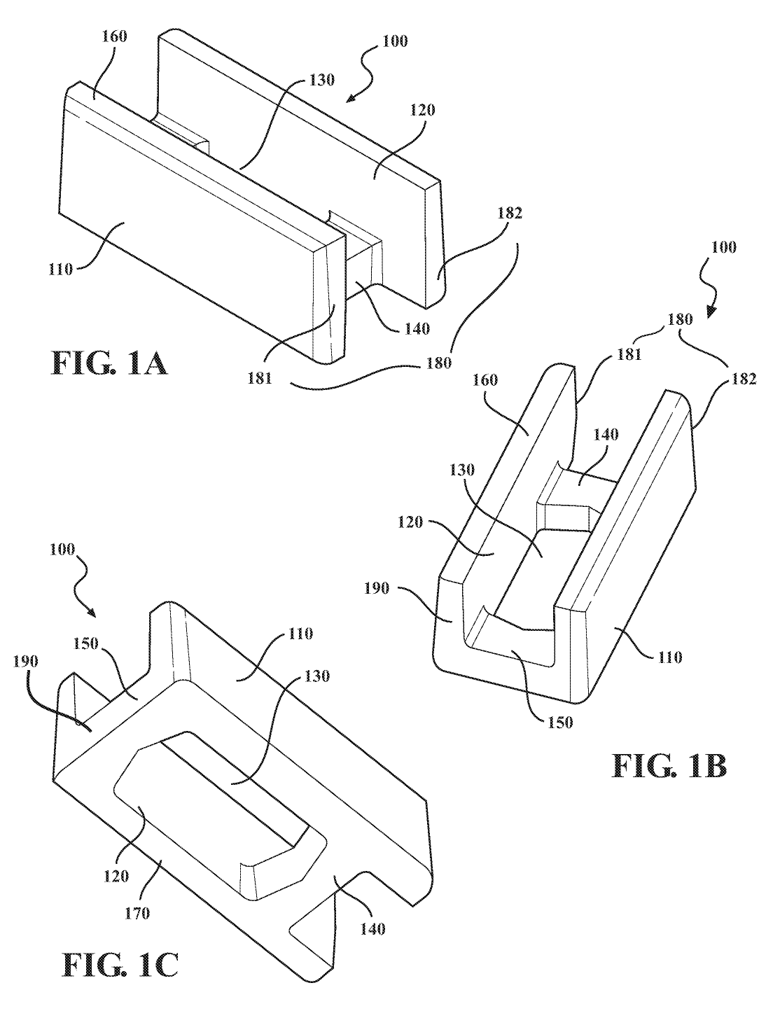

Referring to FIGS. 1A-1C, perspective views of an exemplary precast hollow block 100 having a height of about 18 inches are shown. The hollow block 100 may be used in the construction of retaining walls and free standing walls. FIG. 1A shows a side perspective view of the precast hollow block 100. FIG. 1B shows a top perspective view of the precast hollow block 100. FIG. 1C shows a bottom perspective view of the precast hollow block 100. The hollow block 100 has a top 160, a bottom 170, and substantially planar, opposed sides 110 and 120 that include the front surface and back surface of the hollow block 100, respectively. The front surface and back surface of the sides 110 and 120 are textured such that they may imitate natural stone or other aesthetically pleasing materials.

The sides 110 and 120 are connected together and spaced apart from one another by one or more lateral connecting ribs 140 and 150, to form at least one hollow interior space 130 in the center of the hollow block 100. The first connecting rib 140 and the second connecting rib 150 may be of different lengths, shape, size, and thickness, as well as being in different locations on the hollow block 100, depending on the particular requirements and specifications of the wall. Also, the first connecting rib 140 and the second connecting rib 150 may be made from a variety of materials, such as plastic, metal, and reinforcing steel.

The at least one hollow interior space 130 is adapted to receive and hold at least one filling material. In some embodiments, the filling material may be stone, concrete, or other functionally similar filling materials. The pouring of this filling material to match the grade of the wall provides a smooth, level surface for coping that can eliminate the expense and time commitment of on-site coping projects. In addition, the pouring of these filling materials results in the formation of solid walls for flood prevention, force protection, and other related applications. In addition, the pouring of these filling materials results in the formation of solid walls for flood prevention, force protection, and other related applications. In some embodiments, the solid walls can provide these benefits without the addition of a coping cap.

In the illustrated embodiment, the first connecting rib 140 and the second connecting rib 150 extend laterally parallel to one another along the hollow block 100. The first connecting rib 140 is positioned approximately at the center of the hollow block 100 and the second connecting rib 150 is positioned approximately at one end of the hollow block 100. As a result, two substantially parallel legs 181 and 182 are defined on a first end 180 of the hollow block 100. By positioning the first connecting rib 150 at approximately the center of the hollow block 100, the hollow interior space 130 of the hollow block 100 can better vertically align when the hollow block 100 is stacked with other hollow blocks on a running bond (i.e., a half-block offset). As a result, the hollow interior spaces 130 vertically align through the resulting wall formed from the hollow blocks 100.

In other embodiments, both connecting ribs 140 and 150 may be positioned towards the center of the hollow block 100 in order to define four substantially parallel legs on a second end 190 of the hollow block 100. At least one of the first end 180 and the second end 190 of the hollow block 100 may be cut in order to accommodate various wall construction requirements and allow for the formation of non-planar walls.

During the construction of a wall, some blocks may need to be cut shorter prior to their placement on the wall due to various design features or to accommodate a slope or angle on the wall. When a portion of the wall is placed at an angle to the rest of the wall or when the wall follows an arc or free-form curve, blocks are cut vertically to construct non-planar walls where one face of the wall is shorter than another. In some embodiments, the hollow block 100 may be cut in the field such that the top 160 is at a different angle relative to the bottom 170. The ability to cut the hollow block 100 in the field allows a coping cap to match any grade behind the wall. Instead of cutting the sides 110 and 120 in the field, in an alternative embodiment, the sides 110 and 120 may be poured at an angle to match the grade in the field.

The hollow block 100 may be securely connected to other blocks of different sizes, shapes, and orientations; wall components; wall panels; concrete footings; earthen anchorages, and the like. Each hollow block 100 may be configured to connect with other blocks when the blocks are stacked atop one another or arranged side-by-side to form a wall. This connection can increase wall stability by restricting the movement between adjacent blocks. The hollow block 100 may also be adapted to align with known locking and alignment elements, such as knobs and grooves, tabs, or nodes, to match existing wall batters.

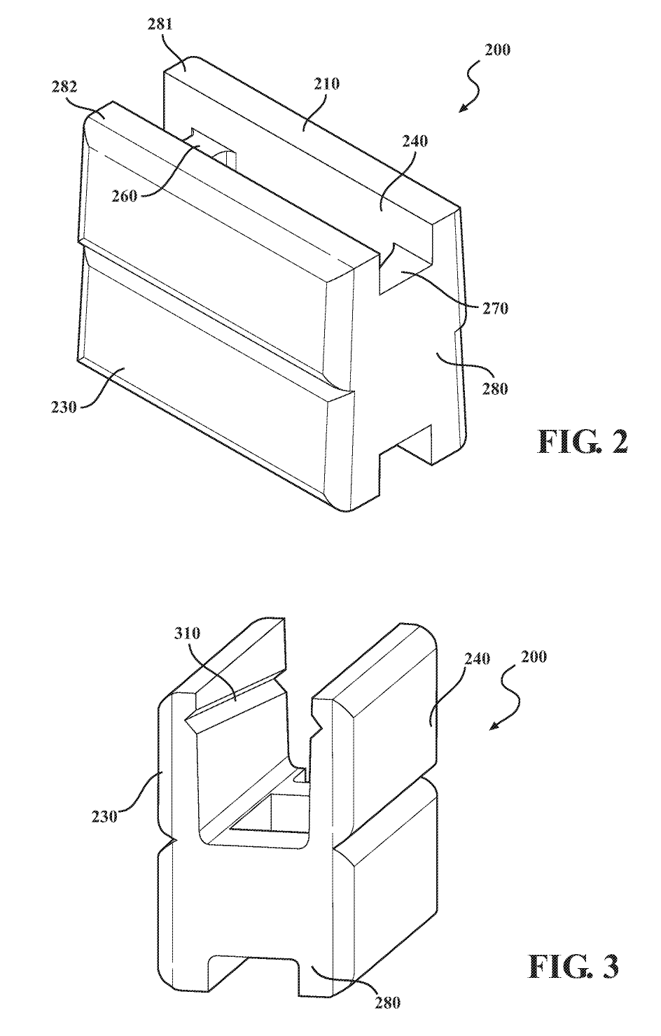

Referring to FIG. 2, FIG. 2 shows a side perspective view of an exemplary precast hollow block 200 having a height of about 36 inches. In this embodiment, the height is about twice the height of commonly used hollow blocks, including the hollow block 100 shown in FIGS. 1a-1c. The hollow block 200 has a length of about 46 inches, which is about equal to the length of commonly used blocks, including the hollow block 100 shown in FIGS. 1a-1c. In some embodiments, the hollow block 200 has a height of about 36 inches and length of about 92 inches, both the height and the length are about twice the height and length of commonly used blocks, including the hollow block 100 shown in FIGS. 1a-1c. In another embodiment, the hollow block 200 has a height that is about 18 inches, which is equal to the height of commonly used blocks, including the hollow block 100 shown in FIGS. 1a-1c and a length of about 92 inches, which is about twice the length of commonly used blocks, including the hollow block 100 shown in FIGS. 1a-1c.

The hollow block 200 has a top 210, a bottom (not shown), and substantially planar, opposed sides 230 and 240 that include the front surface and back surface of the hollow block 200. The front surface and back surface of the sides 230 and 240 are textured such that they may imitate natural stone or other aesthetically pleasing materials.

The opposed sides 230 and 240 are connected together and spaced apart from one another by one or more lateral connecting members, such as connecting ribs 260 and 270, to form at least one hollow interior space (not shown) in the center of the hollow block 200. The connecting ribs 260 and 270 may be of different lengths, shape, size, and thickness, as well as being in different locations on the hollow block 200, depending on the particular requirements and specifications of the wall. Also, the connecting ribs 260 and 270 may be made from a variety of materials, such as plastic, metal, and reinforcing steel.

In an exemplary embodiment, the at least one hollow interior space may be adapted to receive and hold at least one filling material, such as stone and concrete, after the hollow block 200 is positioned on a wall. The pouring of these filling materials to match the grade of the wall provides a smooth, level surface for coping that can eliminate the expense and time commitment of on-site coping projects. In addition, the pouring of these filling materials results in the formation of solid walls for flood prevention, force protection, and other related applications. In some embodiments, the solid walls can provide these benefits without the addition of a coping cap.

In the illustrated embodiment, the connecting ribs 260 and 270 can extend parallel to one another and the first connecting rib 260 is positioned at approximately the center of the hollow block 200 and the second connecting rib 270 is positioned at approximately one end of the hollow block 200. As a result, two substantially parallel legs 281 and 282 form on a first end of the hollow block 200. By positioning the first connecting rib 260 at approximately the center of the hollow block 100, the hollow interior space 130 of the hollow block 200 can better vertically align when the hollow block 200 is stacked with other hollow blocks on a running bond (i.e., a half-block offset). As a result, the hollow interior spaces 130 vertically align through the resulting wall formed from the hollow blocks 200.

In other embodiments, both connecting ribs 260 and 270 may be set further towards the center of the hollow block 200 in order to form four substantially parallel legs on a second end 280 of the hollow block 200. At least one of the first end and the second end 280 of the hollow block 200 may be cut in order to accommodate various wall construction requirements and allow for the formation of non-planar walls.

During the construction of a wall, some blocks may need to be cut shorter prior to their placement on the wall due to various design features or to accommodate a curve or angle on the wall. When a portion of the wall is placed at an angle to the rest of the wall or when the wall follows an arc or free-form curve, blocks are cut vertically to construct non-planar walls where one face of the wall is shorter than another. In some embodiments, the hollow block 200 may be cut in the field such that the top 210 is at a different angle relative to the bottom. The ability to cut the hollow block 200 in the field allows a coping cap to match any grade behind the wall. Instead of cutting the sides 230 and 240 in the field, in an alternative embodiment, the sides 230 and 240 may be poured at an angle to match the grade in the field.

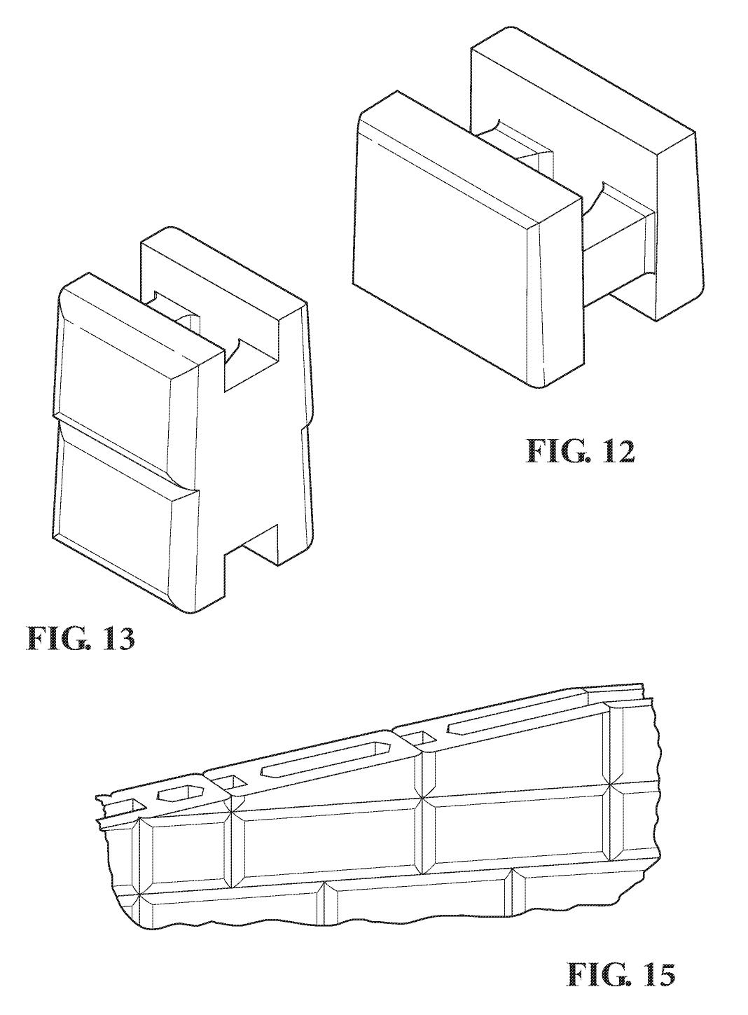

In some embodiments, a full 18-inch cut may be made through the hollow block 200 without having the hollow block 200 lose any of its support. Typically, transitioning the slope from one course to another results in the last block having a height that is only a fraction of the height (about 2-3 inches or less) of blocks having their full height. Consequently, the face textures are difficult to support or missing entirely from the finished wall. However, in the hollow block 200, the texture is integrated into the row of blocks located below it, which results in a well-supported texture and allows for a designer or installer to more easily and quickly accommodate the grade as it transitions from one row of blocks to another (as shown in FIG. 12).

The hollow block 200 may be securely connected to other blocks of different sizes, shapes, and orientations; wall components; wall panels; concrete footings; earthen anchorages, and the like. Each hollow block 200 may be configured to connect with other blocks when the blocks are stacked atop one another or arranged side-by-side to form a wall. This connection can increase wall stability by restricting the movement between adjacent blocks. The hollow block 200 may also be adapted to align with known locking and alignment elements, such as knobs and grooves, tabs, or nodes, to match existing wall batters.

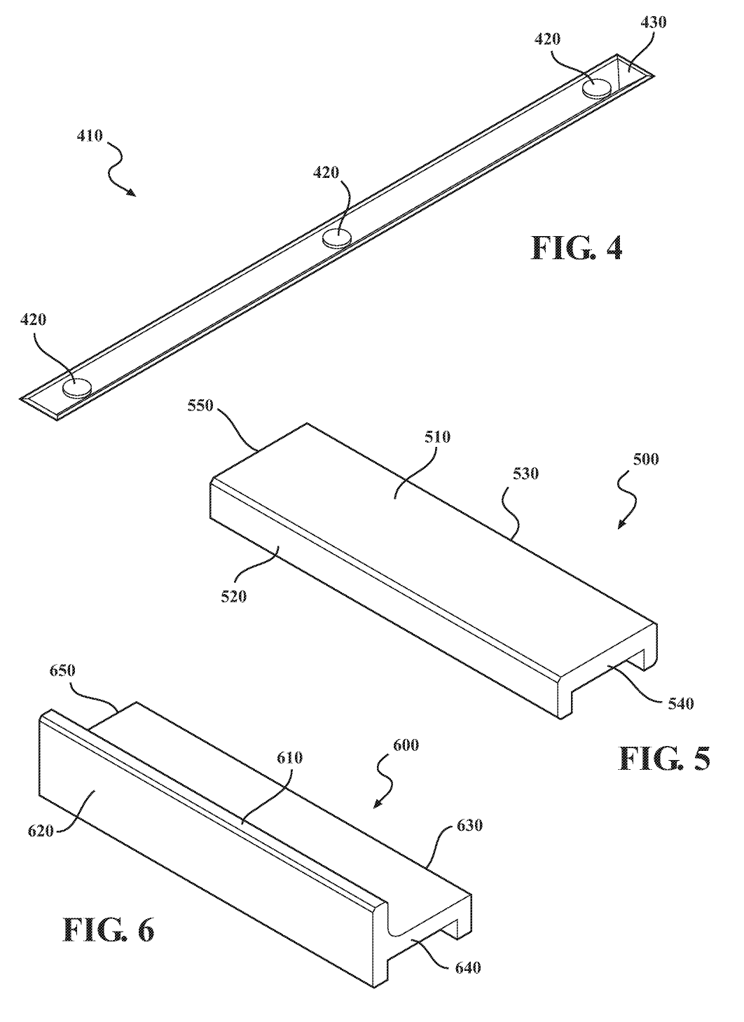

In order to make it easier and quicker for an operator to cut hollow blocks in the field, some embodiments involve the formation of hollow blocks that are precast with at least one scoring feature. Referring to FIG. 3, FIG. 3 shows a side perspective view of the exemplary precast hollow block 200 of FIG. 2 comprising a scoring feature 310. Even though the exemplary precast hollow block 200 shown in FIG. 3 has one scoring feature 310 precast on the side 230 at a substantially horizontal angle with respect to the hollow block 200, a plurality of scoring features may be precast in the same precast hollow block 200 at various locations and angles. The scoring feature 310 is a groove or marking created in the concrete of the hollow block 200 using a scoring insert (shown in FIG. 4) to allow the hollow block 200 to be cut to desired grades. As a result, the hollow block 200 can be easily used during the formation of a wall that provides a smooth, level surface for on-site coping projects.

Referring to FIG. 4, FIG. 4 shows a top view of a scoring insert 410 for creating the scoring feature 310 on the hollow block 200 shown in FIG. 3. The scoring insert 410 comprises at least one magnet 420 attached/embedded into the scoring insert 410 and a substantially triangular end point 430. FIG. 4 shows the scoring insert 410 having three magnets 420 attached/embedded into the scoring insert 410. The scoring insert 410 may be made from a variety of resilient, durable materials, such as, but not limited to steel. The magnets 420 allow the scoring insert 410, to be easily positioned in desired locations within the form used for manufacturing the hollow block 200. The magnets 420 may be any size, strength, type, or material, depending on the type of scoring feature 310 to be created in the hollow block 200. Due to the permanent attachment of the magnets 420 to the scoring insert 410, the scoring insert 410 remains attached to the hollow block 200 during removal of the hollow block 200. As a result, the hollow block 200 can be easily removed, and the scoring insert 410 can be easily replaced or repositioned in the form during setup for a new concrete pour.

Each scoring insert 410 can be positioned at any angle on the hollow block 200 relative to the position of hollow block 200 on a fully assembled wall. In some embodiments, the substantially triangular end point 430 on the scoring insert 410 may serve as a guide for cutting the precast hollow block 200 at specific locations since it provides an easier access point/guide. Since there is less concrete material at the substantially triangular end point 430 than at other locations on the hollow block 200, an operator will have an easier time cutting into or fracturing the hollow block 200 along the scoring feature 310 and removing more material from the hollow block 200. This is particularly the case if the operator does not have the appropriate tools (concrete saws) to cut hollow blocks that do not have a scoring feature.

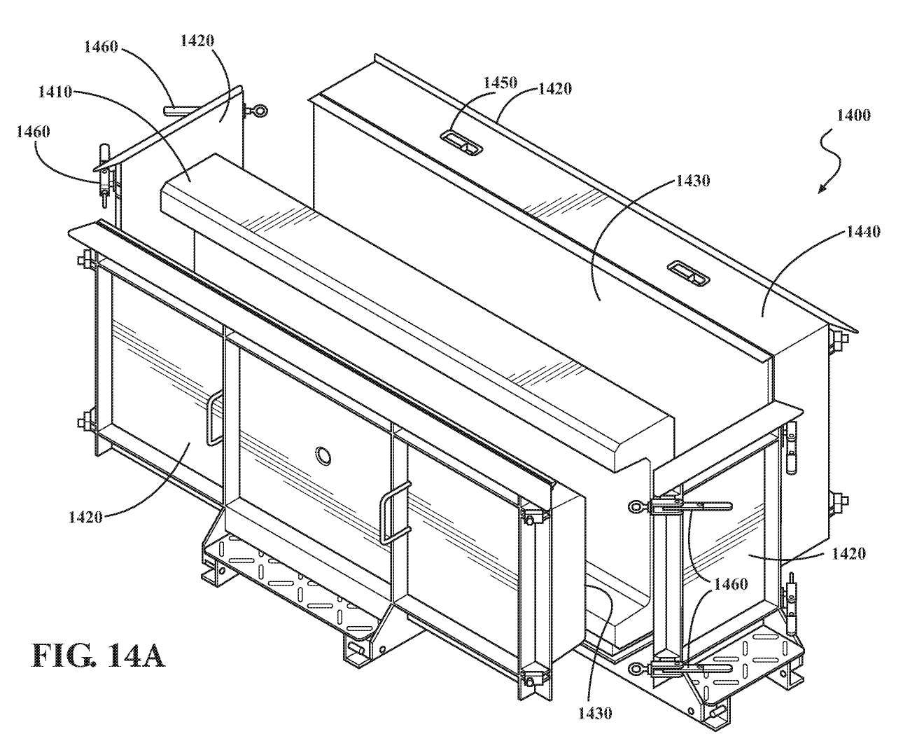

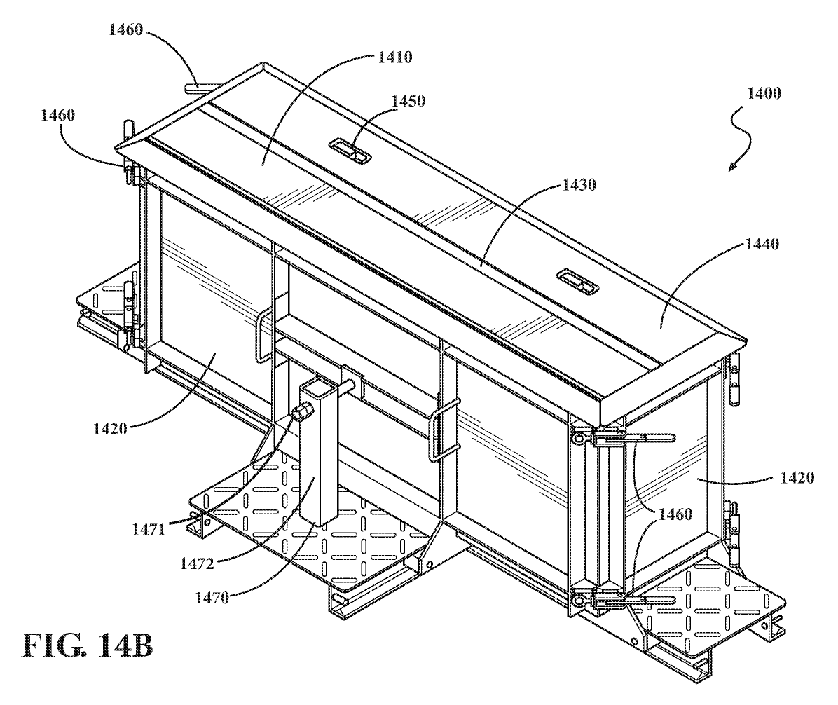

Alternative embodiments of the hollow blocks 100 and 200, as shown in FIGS. 1A-1C, 2, and 3, can include hollow blocks of different sizes, shapes and orientations. In one embodiment, a hollow block may form a horizontal corner with angles of varying degrees, such as, but not limited to 90 degrees. In another embodiment, the hollow block may be installed on a wall in a vertical orientation and may have textured faces on its ends. Some other embodiments of the hollow block may have other dimensions combinations, such as, but not limited to a height from about 6 inches to about 45 inches and a length of about 10 inches to about 120 inches. For example, FIG. 13 shows a hollow block having about half the length as the hollow block having a height of about 18 inches depicted in FIGS. 1A-1C. Similarly, FIG. 14 shows a hollow block having about half the length as the hollow block having a height of about 36 inches depicted in FIG. 2. In addition, the thickness and texture of the sides may vary between embodiments. In some embodiments, the hollow blocks 100 and 200 may be known as MAGIC™ blocks.

A coping cap comprises at least one coping block attachable along the top of a wall. Referring to FIG. 5, FIG. 5 shows a perspective view of an exemplary precast coping block 500 having a height of about 12 inches. In this particular example, the coping block 500 has a height of about 12 inches and a length up to about 120 inches. The coping block 500 may be fabricated from a particular type of concrete, cement, reinforcing steel, or other functionally equivalent reinforcing materials. The coping block 500 has a top 510, a bottom (not shown), substantially planar, opposed sides 520 and 530 having a rectangular shape that include the front surface and back surface of the coping block 500, and ends 540 and 550. In addition to the front surface and back surface of the sides 520 and 530 being textured, one or both of the ends 540 and 550 also may be textured, particularly when they are visible in a finished wall.

At least one of the ends 540 and 550 of the coping block 500 may be cut in order to accommodate various wall construction requirements, ensure accurate joints, and allow for the formation of non-planar walls. During the construction of a wall, some blocks may need to be cut shorter prior to their placement on the wall due to various design features or to accommodate a curve or angle on the wall. When a portion of the wall is placed at an angle to the rest of the wall or when the wall follows an arc or free-form curve, blocks are cut vertically to construct non-planar walls where one face of the wall is shorter than another. In some embodiments, the coping block 500 may be configured to match any grade behind the wall by casting the ends 540 and 550 at an angle other than one that is perpendicular to the top 510 and the bottom. In other embodiments, the coping block 500 may be configured to match any grade behind the wall by cutting the ends 540 and 550 at an angle other than one that is perpendicular to the top 510 and the bottom.

The coping block 500 may be securely affixed and positioned along the top of a wall that includes precast hollow blocks, as depicted in FIGS. 1A-1C, 2, and 3 in order to provide a flat surface on top of the wall and to provide a desired aesthetic component to the wall. The coping block 500 may also be securely affixed and positioned to other blocks of different sizes, shapes, and orientations; wall components; wall panels; concrete footings; and the like. The coping block 500, along with other coping blocks, may also be configured to accommodate mounting structures for fences, railings, site lighting, utilities, traffic barriers, and functionally equivalent structures on the top of the coping block 500.

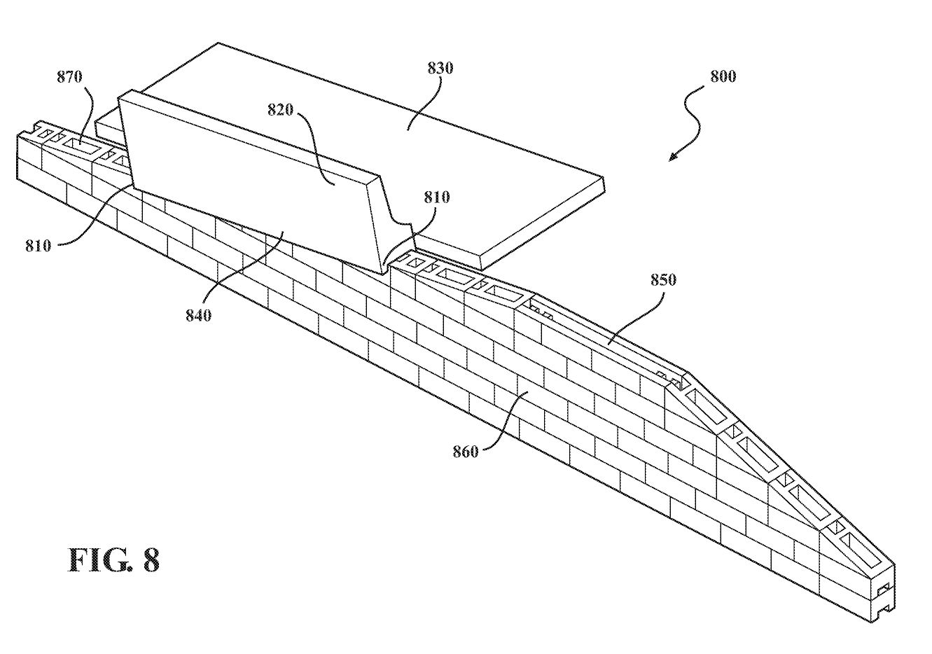

In exemplary embodiments, the traffic barrier may be precast into the coping block 500, as illustrated in FIG. 8. In an alternative embodiment, the coping block 500 may be fabricated with reinforcing rods (rebar) to allow for incorporation with a cast-in-place moment slab and/or a cast-in-place traffic barrier. This allows for a secure connection with the traffic barrier in order to help prevent its tipping and overturning when impacted by a moving vehicle.

Referring to FIG. 6, FIG. 6 shows a perspective view of an exemplary precast coping block 600 having a height of about 24 inches. In this particular example, the coping block 600 has a height of about 24 inches and a length up to about 120 inches. The coping block 600 may be fabricated from a particular type of concrete, cement, reinforcing steel, or other functionally equivalent reinforcing materials. The coping block 600 has a top 610, a bottom (not shown), a substantially planar, rectangular-shaped front side 620 including a front surface, a substantially planar, rectangular-shaped back side 630 including a back surface, and ends 640 and 650. In addition to the top 610 and the surfaces of the front side 620 and the back side 630 being textured, one or both of the ends 640 and 650 also may be textured, particularly when they are visible in a finished wall.

In one embodiment, the front side 620 is about 12 inches taller than the back side 630 due to a void on the back side 630. As a result, fencing, railings, or other functionally equivalent barriers, such as a traffic barrier, may be installed in the void of the coping block 600. At least one of the ends 640 and 650 of the coping block 600 may be cut in order to accommodate various wall construction requirements, ensure accurate joints, and allow for the formation of non-planar walls. During the construction of a wall, some blocks may need to be cut shorter prior to their placement on the wall due to various design features or to accommodate a curve or angle on the wall. When a portion of the wall is placed at an angle to the rest of the wall or when the wall follows an arc or free-form curve, blocks are cut vertically to construct non-planar walls where one face of the wall is shorter than another. In some embodiments, the coping block 600 may be configured to match any grade behind the wall by casting the ends 640 and 650 at an angle other than one that is perpendicular to the top 610 and the bottom. In other embodiments, the coping block 600 may be configured to match any slope of the wall by cutting the ends 640 and 650 at an angle other than one that is perpendicular to the top 610 and the bottom.

The coping block 600 may be securely affixed and positioned along the top of a wall that includes precast hollow blocks, as depicted in FIGS. 1A-1C, 2, and 3, in order to provide a flat surface on top of the wall. The coping block 600 may also be securely affixed and positioned to other blocks of different sizes, shapes, and orientations; wall components; wall panels; concrete footings; and the like. The coping block 600, along with other coping blocks, may also be configured to accommodate mounting structures for fences, railings, site lighting, utilities, traffic barriers, and functionally equivalent structures on the top of the coping block 600.

In exemplary embodiments, the traffic barrier may be integrated into the coping block 600 in a precast manner, as illustrated in FIG. 8. In an alternative embodiment, the coping block 600 may be fabricated with reinforcing rods (rebar) to allow for incorporation with a cast-in-place moment slab and/or a cast-in-place traffic barrier. This allows for a secure connection with the traffic barrier in order to help prevent its tipping and overturning when impacted by a moving vehicle.

The pouring of filling materials into the hollow interior space 130 of the hollow block 100 and the coping block 600 increase the total height of any resulting wall. The result is that the coping block 600 becomes part of the formed retaining wall. This creates a more efficient wall system that requires fewer hollow blocks and much fewer concrete to create a wall having the same height. In some embodiments, landscaping, soil, concrete, asphalt, and functionally similar materials may be placed within close proximity of the front side 620 of the coping block 600 to provide additional support for the wall in order to limit overturning and sliding. Further, the coping block 600 may be configured to accommodate at least one vertical face panel that may extend above and/or below relative the horizontal portion(s) of the coping block 600. The vertical face panel may be supported by the other blocks surrounding the coping block 600.

Alternative embodiments of the coping blocks 500 and 600, as shown in FIGS. 5 and 6, respectively, can include coping blocks of different sizes, shapes and orientations. For example, a coping block may form a horizontal corner with angles of varying degrees, such as, but not limited to 90 degrees. Further, in another example, the hollow block may be installed on a wall in a vertical orientation and may have textured faces on its ends. Other embodiments of the hollow block may have other dimensions combinations, such as, but not limited to a height from about 12 inches to about 24 inches and a length of up to about 120 inches. In addition, the thickness and texture of the sides may vary between embodiments.

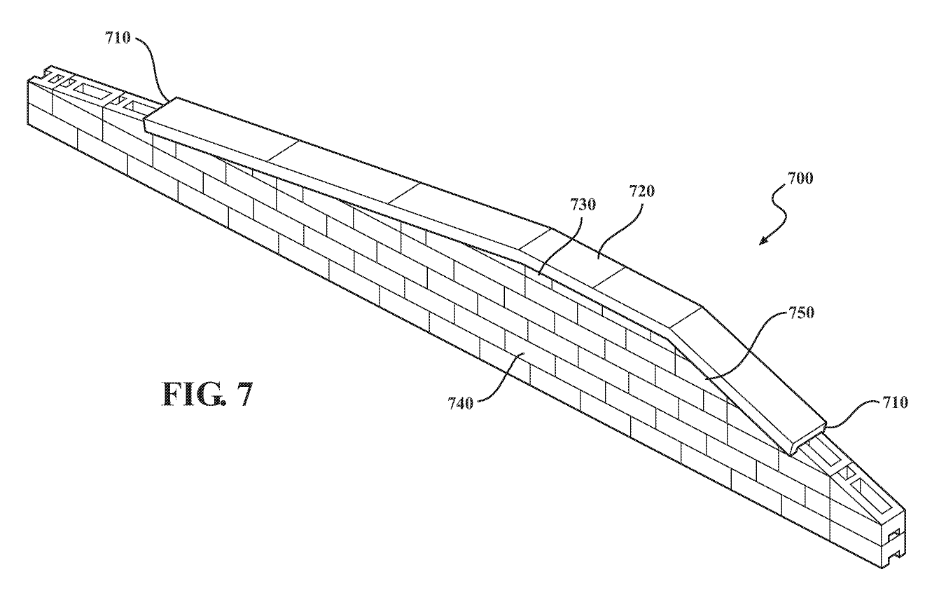

Referring to FIG. 7, FIG. 7 shows a perspective view of an exemplary wall 700 comprising a coping cap 710 affixed along the top of the wall 700. In the illustrated embodiment, the coping cap 710 comprises at least one coping block 720 installed on top of a first set of a plurality of hollow blocks 730. Each coping block 720 has a height of about 12 inches and is used to protect the wall 700 from degradation and to provide a finished surface on top of the wall 700. Each of the hollow blocks 730 in the first set is has a height of about 18 inches. The wall 700 also comprises a plurality of stacked rows of retaining blocks 740, which are stacked to a predetermined height at the desired batter and a second set of a plurality of hollow blocks 750. Each of the hollow blocks 750 in the second set has a height about twice the height of each of the hollow blocks 730 in the first set. In one embodiment, each of the hollow blocks 750 in the second set has a height of about 36 inches. In the finished wall 700, the first set of hollow blocks 730 are stacked on top of the second set of hollow blocks 750, which are stacked on top of the retaining blocks 740.

The at least one coping block 720 is configured to allow for secure structural connections with the first set of hollow blocks 730, the retaining blocks 740, and the second set of hollow blocks 750. In addition, the at least one coping block 720, the first set of hollow blocks 730, the retaining blocks 740, and the second set of hollow blocks 750 are configured to securely connect with wall components; wall panels; concrete footings; earthen anchorages, and the like. The wall components; wall panels; concrete footings; and earthen anchorages may be added on top of or around the coping cap 710. These connections can increase wall stability by restricting the movement between adjacent blocks.

In some embodiments, the at least one coping block 720, the first set of hollow blocks 730, and the second set of hollow blocks 750 may be precast at the desired grade and labeled according to their orientation on the wall 700. In alternative embodiments, the at least one coping block 720, the first set of hollow blocks 730, and the second set of hollow blocks 750 may be cut to the desired grade at the construction site of the wall 700. In some embodiments, fencing, railings, or other functionally equivalent barriers, such as a traffic barrier, may be installed on top of the coping cap 710.

Referring to FIG. 8, FIG. 8 shows a perspective view of an exemplary wall 800 comprising a coping cap 810 with an integrated traffic barrier 820 and cast-in-place moment slab 830 affixed along the top of the wall 800. In the illustrated embodiment, the coping cap 810 comprises a coping block 840 that has a height of about 24 inches and is used to protect the wall 800 from degradation and to provide a finished surface on top of the wall 800. The wall 800 also comprises a first set of a plurality of hollow blocks 850 on its top row. Each of the hollow blocks 850 in the first set has a height of about 18 inches. Further, the wall 800 comprises a plurality of stacked rows of retaining blocks 860, which are stacked to a predetermined height at the desired batter and a second set of a plurality of hollow blocks 870. Each of the hollow blocks 870 in the second set has a height about twice the height of the hollow blocks 850 in the first set. In one embodiment, each of the hollow blocks 870 in the second set has a height of about 36 inches.

The coping block 840 is configured to allow for secure structural connections with the first set of hollow blocks 850, the retaining blocks 860, and the second set of hollow blocks 870. In addition, the coping block 840, the first set of hollow blocks 850, the retaining blocks 860, and the second set of hollow blocks 870 are configured to securely connect with wall components; wall panels; concrete footings; earthen anchorages, and the like. These connections can increase wall stability by restricting the movement between adjacent blocks.

In some embodiments, the coping block 840, the first set of hollow blocks 850, and the second set of hollow blocks 870 may be precast at the desired grade and labeled according to their orientation on the wall 800. In alternative embodiments, the coping block 840, the first set of hollow blocks 850, and the second set of hollow blocks 870 may be cut to the desired grade at the construction site of the wall 800.

In some embodiments, fencing, railings, landscaping, soil, plants, or other functionally equivalent materials may be installed on top of the coping cap 810. Traffic barriers, moment slabs, sidewalks, or other functionally equivalent materials may be cast-in-place on top of the coping cap 810.

Alternative embodiments of the walls 700 and 800, respectively shown in FIGS. 7 and 8, can include walls that form a horizontal corner with angles of varying degrees, such as, but not limited to 90 degrees. When a portion of the wall is placed at an angle to the rest of the wall or when the wall follows an arc or free-form curve, blocks are cut to construct non-planar walls where one face of the wall is shorter than another.

As disclosed above, the hollow block provides a smooth, level surface for coping that can eliminate the expense and time commitment of on-site coping project. Additionally, in alternative embodiments, the system disclosed herein may be used for other types of applications involving walls and non-wall structures. Specifically, the precast hollow block wall system disclosed herein may be used for flood management walls with a watertight cast-in-place center core, rail bed ballast retention, bridge abutments, barrier walls with a cast-in-place center core, parapet walls, sound attenuation walls, visual screen walls, force protection structures, blast mitigation structures, and the like.

In an exemplary embodiment, the precast wall provides a solid core across the entire wall for flood protection. The precast wall comprises the first set of hollow blocks 730 stacked on top of the second set of hollow blocks 750, which are stacked on top of the retaining blocks 740. In some examples, the precast wall does not include the retaining blocks 740. The precast wall also comprises reinforcing steel, such as rebar, and poured-in-place concrete, but no coping cap. The blocks used for this precast wall may be assembled and positioned in areas known to have potential for flooding. The reinforcing steel is placed in prescribed locations on the blocks while the wall is being constructed. Concrete is then poured into the core hollow interior spaces of the wall to create a solid core across the entire wall. The result is the creation of an effectively water-tight wall with greater structural stability. Thus, no separate framework or parts are needed to create the wall. As a result, there are great cost-savings on labor as compared with existing wall construction techniques. In addition, the hollow core block adds mass to the wall cross-section. The result is a more robust and stable wall that can be used as a formwork that can be integrated into the wall. Unlike cast-in-place techniques for wall construction, no post-processing is needed to the wall after concrete is poured.

In another exemplary embodiment, the precast wall provides a solid core across the entire wall for the formation of a barrier. The precast wall comprises the first set of hollow blocks 730 stacked on top of the second set of hollow blocks 750, which are stacked on top of the retaining blocks 740. In some examples, the precast wall does not include the retaining blocks 740. The precast wall also comprises reinforcing steel, such as rebar, and poured-in-place concrete, but no coping cap. The blocks used for this precast wall may be assembled and positioned in areas in need of a barrier. The reinforcing steel is placed in prescribed locations on the blocks while the wall is being constructed. Additional anchoring and/or reinforcement structures may be added to the wall at this time. Concrete is then poured into the core hollow interior spaces of the wall to create a solid core across the entire wall, effectively tying all the wall blocks into a single mass. As a result, any impact to the wall blocks would be distributed across the wall.

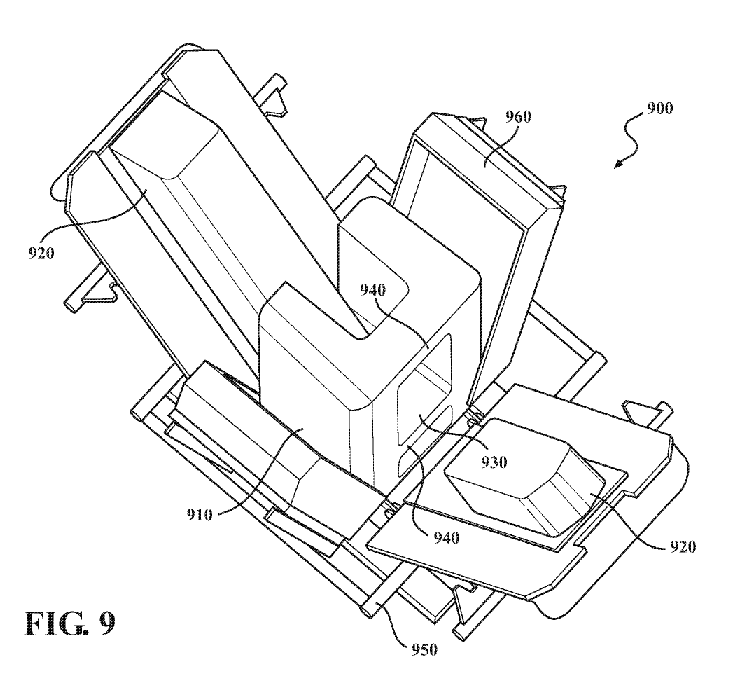

Referring to FIG. 9, FIG. 9 shows a perspective view of an exemplary form 900 for manufacturing a hollow block 910 having a height of about 18 inches. In the illustrated embodiment, the form 900 has a height of about 18 inches and comprises a plurality of doors 950 and a base comprising one or more face molds 960 used for insertion of one or more core inserts 920. The one or more face molds 960 create simulated rock faces on the hollow block 910, while the one or more core inserts 920 impart a desired configuration to the hollow block 910. The one or more face molds 960 and one or more core inserts 920 may be fabricated into a variety of shapes and sizes and from a variety of materials, such as, but not limited to rubber, steel, and plastic.

At least two doors 950 clamp to each other to form at least one hollow interior space 930 in the center of the hollow block 910 into which the concrete is poured. The doors 950 swing or slide out of the way after the hollow block 910 is cured. In some embodiments, the doors 950 may open and close on a sliding rail system, hinges, or a combination of both.

The form 900 is configured to locate and support any necessary concrete reinforcement materials for the manufacturing of the hollow block 910. The form 900 is also configured to locate and support lateral connecting members, such as connecting ribs 940, located in the hollow block 910.

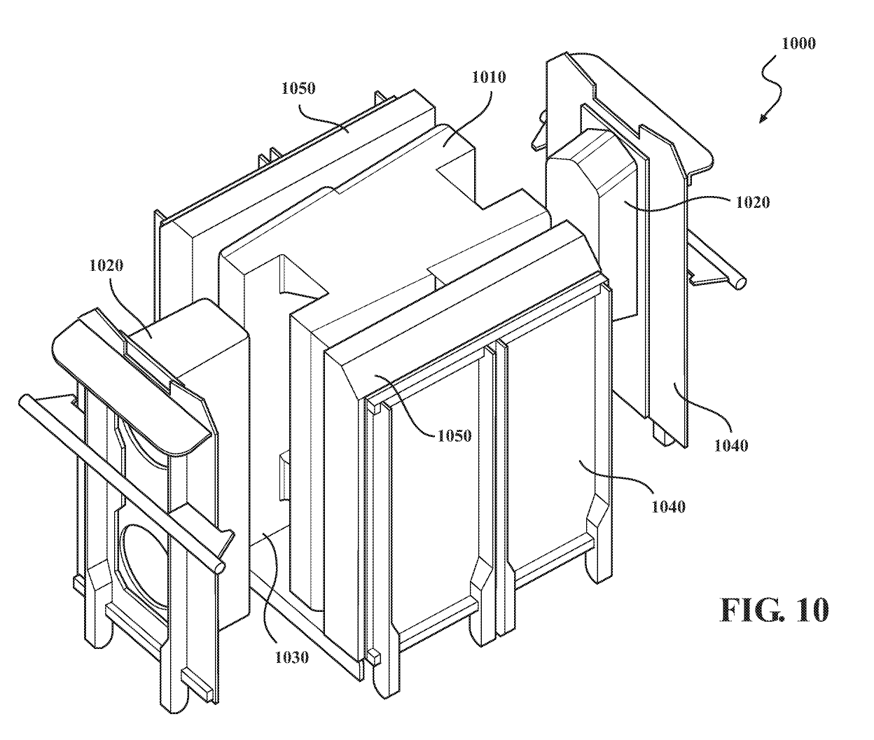

Referring to FIG. 10, FIG. 10 shows a perspective view of an exemplary form 1000 for manufacturing a hollow block 1010 having a height of about 36 inches. In the illustrated embodiment, the form 1000 has a height of about 36 inches and comprises a plurality of doors 1040 and a base comprising one or more face molds 1050 used for insertion of one or more core inserts 1020. The one or more face molds 1050 create simulated rock faces on the hollow block 1010, while the one or more core inserts 1020 impart a desired configuration to the hollow block 1010. The one or more face molds 1050 and one or more core inserts 1020 may be fabricated into a variety of shapes and sizes and from a variety of materials, such as, but not limited to rubber, steel, and plastic.

At least two doors 1040 clamp to each other to form at least one hollow interior space 1030 in the center of the hollow block 1010 into which the concrete is poured. The doors 1040 swing or slide out of the way after the hollow block 1010 is cured. In some embodiments, the doors 1040 may open and close on a sliding rail system, hinges, or a combination of both.

The form 1000 is configured to locate and support any necessary concrete reinforcement materials for the manufacturing of the hollow block 1010. The form 1000 is also configured to locate and support lateral connecting members, such as connecting ribs (not shown), located in the hollow block 1010. In some embodiments, the form 1000 comprises doors or side walls that open and close on a sliding rail system, hinges, or a combination of both.

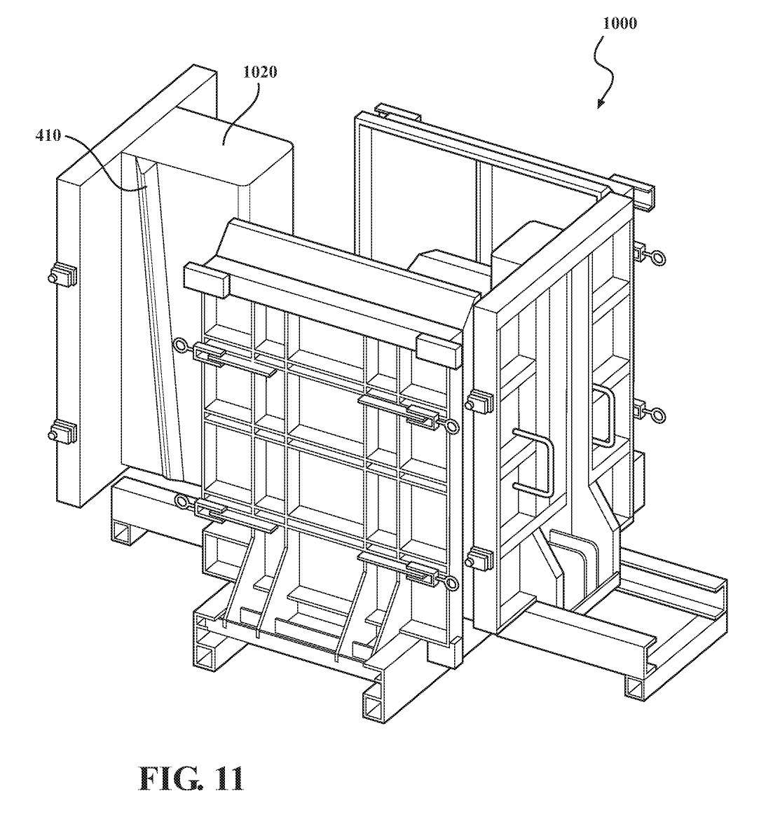

Referring to FIG. 11, FIG. 11 shows a perspective view of the scoring insert 410 of FIG. 4 implemented on the exemplary form 1000 disclosed in FIG. 10. The scoring insert 410 is attached to sides of the core insert 1020 using magnets embedded in the scoring insert 410. However, the scoring insert 410 is readily removable from the core insert 1020 to prevent the core insert 1020 from being trapped inside hollow blocks. The magnets allow the scoring insert 410 to be easily positioned in desired locations within the form 1000. Due to the permanent attachment of the magnets to the scoring insert 410, the scoring insert 410 remains attached to a hollow block (shown as 1010 in FIG. 10) during removal of the hollow block 1010 from the form 1000. In some cases, the extra or unneeded scoring inserts 410 may be readily removed from the form 1000 when the doors 1040 are removed. As a result, the scoring insert 410 can be easily replaced or repositioned in the form during setup for a new concrete pour.

In some embodiments, a coping cap including coping blocks 500 and 600, as shown in FIGS. 5 and 6, respectively, may be manufactured with a coping cap form, as shown in FIGS. 14A and 14B. FIG. 14A shows a perspective view of an exemplary coping form 1400 for manufacturing a coping cap 1410 in its open orientation. In this illustrated embodiment, the coping form 1400 includes a plurality of doors 1420 that may open and close on a sliding rail system, hinges, or a combination of both attached to the base of the coping form 1400. In some embodiments, the coping form 1400 comprises four doors. The base comprises a plurality of texture molds 1430 that create simulated rock faces on the coping blocks of the coping cap 1410. Each of the plurality of texture molds 1430 comprises a rubber mat that can be interchanged to create different textures on the coping blocks.

The plurality of texture molds 1430 are configured for insertion of at least one removable insert 1440 that imparts a desired configuration to the coping blocks of the coping cap 1410. Each removable insert 1440 may be fabricated from a variety of materials, such rubber, steel, and plastic and may be fabricated into a variety of shapes and sizes. Thus, each removable insert 1440 can be readily interchanged to create different coping blocks. Each removable insert 1440 comprises an integrated lifting insert 1450 having a removable cover in order to allow for easier removal and replacement of the removable insert 1440. In the illustrated embodiment, the height of the coping cap 1410 manufactured by the coping form 1400 is about 12 inches. In other embodiments, the removable insert 1440 may be removed and replaced with a different removable insert to allow for the creation of a coping cap having a height of about 24 inches.

Each lifting insert 1450 is integrated within a removable insert 1440 and includes a removable cover. In some embodiments, the removable cover is made from molded rubber. As a result, concrete or other types of filling material can cover the lifting insert 1450 without creating problems with leaking or stripping.

The coping form 1400 further comprises a plurality of clamps 1460, each of the clamps 1460 is positioned at about a 45 degree angle on a plurality of doors 1420. In some embodiments, each of the clamps 1460 is positioned on two doors 1420 in the open orientation of the coping form 1400. Due to the angle of each of the clamps 1460 with respect to the doors 1420, each clamp 1460 may readily interlock with a door 1420 adjacent to the door 1420 where the clamp 1460 is positioned. This allows the clamp 1460 to pull two doors 1420 simultaneously shut, causing the coping form 1400 to enter a closed orientation, as illustrated in FIG. 14B.

Referring to FIG. 14B, FIG. 14B shows a perspective view of an exemplary coping form 1400 for manufacturing the coping cap 1410 of FIG. 14A in its closed orientation. In its closed orientation, the coping form 1400 comprises a door jack assembly 1470 that includes a jack screw 1471 and a post 1472. The door jack assembly 1470 is attached to at least one door 1420. Once the coping cap 1410 is cured, the jack screw 1471 reacts against the post 1472 to pull the door 1420 out of the concrete. As a result, nothing is required from the operator of the coping form 1400, besides a standard impact driver. If the door 1420 needs to be opened further or removed altogether, the post 1472 can be readily removed from the base.

The coping cap form 1400 may be configured to locate and support any necessary concrete reinforcement materials and mounting structures for fences, railings, site lighting, utilities, and functionally equivalent structures on the top of the coping block. Also, the coping cap form 1400 may be configured to incorporate a traffic barrier into a coping block or wall and to incorporate voids for landscaping, soil, concrete, and other functionally equivalent materials. Further, the coping cap form 1400 may be configured to locate and support reinforcement for cast-in-place traffic barriers, cast-in-place moment slabs, and connectors to other wall components.

Referring to FIG. 15, FIG. 15 shows a perspective view of an exemplary wall comprising a textured hollow block having a height of about 36 inches. In this embodiment, the textured hollow block is integrated into the wall in order to essentially mimic the appearance of two hollow blocks, each having a height of about 18 inches, stacked on top of each other. As a result, the textured faces are integrated into the row of blocks located below where it would ordinarily appear. This allows for easier and quicker accommodation of the grade in the wall as it transitions from one row of blocks to another.

It will, of course, be understood that, although particular examples have just been described, the claimed subject matter is not limited in scope to a particular example or limitation. Likewise, an example may be implemented in any combination of compositions of matter, apparatuses, methods or products made by a process, for example.

In the preceding description, various aspects of claimed subject matter have been described. For purposes of explanation, specific numbers, percentages, components, ingredients and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features and examples have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A precast hollow block comprising:
a top;
a bottom;
a front side including a front surface, the front side opposed from a back side including a back surface, each of the front surface and the back surface having a textured surface for imparting a natural stone appearance; and
a first connecting rib extending laterally from the front side to the back side and a second connecting rib parallel to the first connecting rib and extending laterally from the front side to the back side to form a hollow interior space configured for accepting a filling material, wherein the first connecting rib is positioned approximately at the center of the precast hollow block.

2. The precast hollow block of claim 1, further comprising a first end and a second end, the first end including two substantially parallel legs, wherein the two substantially parallel legs are cut prior to assembly of the precast hollow block into a wall.

3. The precast hollow block of claim 2, wherein the wall is non-planar.

4. The precast hollow block of claim 1, further comprising at least one scoring feature for identifying a cut site on the precast hollow block prior to assembly into a wall.

5. The precast hollow block of claim 4, wherein the scoring feature is formed in the precast hollow block with a scoring insert.

6. The precast hollow block of claim 5, wherein the scoring insert comprises at least one magnet and a substantially triangular end point.

7. A precast wall system comprising:
a first set of a plurality of hollow blocks, each of the hollow blocks in the first set comprising:
a top;
a bottom;
a front side including a front surface, the front side opposed from a back side including a back surface, each of the front surface and the back surface having a textured surface; and
a first connecting rib extending laterally from the front side to the back side and a second connecting rib parallel to the first connecting rib and extending laterally from the front side to the back side to form a hollow interior space configured for accepting a filling material, wherein the first connecting rib is positioned approximately at the center of the hollow block;
a second set of a plurality of hollow blocks, wherein the first set of the plurality of hollow blocks is attached to the top of the second set of hollow blocks, each of the hollow blocks in the second set comprising:
a top;
a bottom;
a front side including a front surface, the front side opposed from a back side including a back surface, each of the front surface and the back surface having a textured surface; and
a first connecting rib extending laterally from the front side to the back side and a second connecting rib parallel to the first connecting rib and extending laterally from the front side to the back side to form a hollow interior space configured for accepting a filling material, wherein the first connecting rib is positioned approximately at the center of the hollow block; and
a plurality of stacked retaining blocks, wherein the second set of hollow blocks is attached to the top of the stacked retaining blocks.

8. The precast wall system of claim 7, wherein each of the hollow blocks in the second set has a height about twice the height of each of the hollow blocks in the first set.

9. The precast wall system of claim 8, wherein each of the hollow blocks in the second set has a height of about 36 inches.

10. The precast wall system of claim 8, wherein the first set of hollow blocks, the second set of hollow blocks, and/or the retaining blocks are configured for attachment to soil, a plant, a fence, a railing, a traffic barrier, and/or a site light.

11. The precast wall system of claim 8, further comprising a coping cap including at least one coping block securely attached to the top of the first set of hollow blocks.

12. The precast wall system of claim 11, wherein the coping block comprises a first end, a second end, and a front side including a front surface, the front side opposed from a back side including a back surface, each of the front surface and the back surface having a textured surface.

13. The precast wall system of claim 12, wherein the first end of the coping block and the second end of the coping block are each cast at an angle that matches the slope of a wall.

14. The precast wall system of claim 12, wherein the first end of the coping block and the second end of the coping block are each cut prior to assembly into a wall.

15. The precast wall system of claim 12, wherein the coping block includes rebar configured for incorporating a cast-in-place moment slab or a cast-in-place traffic barrier on the top of a wall.

16. The precast wall system of claim 8, further comprising rebar, wherein the rebar is positioned on the first set of hollow blocks and/or the second set of hollow blocks.

17. The precast wall system of claim 16, wherein the filling material is poured-in place concrete, wherein the poured-in place concrete filling material is configured for forming a water-tight wall.

18. The precast wall system of claim 16, wherein the filling material is poured-in place concrete, wherein the poured-in place concrete filling material is configured for forming a solid core barrier across a wall.

19. A form for manufacturing a hollow block comprising:
a plurality of doors, wherein at least two of the plurality of doors clamp together to form a hollow interior space configured for accepting a filling material; and
a base comprising a plurality of face molds configured for insertion of at least one core insert into the form, wherein the core insert is configured for imparting a shape to the hollow block.

20. The form for manufacturing the hollow block of claim 19, wherein each of the face molds has a textured surface for imparting a natural stone appearance on the hollow block.

21. The form for manufacturing the hollow block of claim 19, further comprises sliding rails and/or hinges, wherein the sliding rails and hinges are configured to open and close each of the doors.

22. The form for manufacturing the hollow block of claim 19, further comprising a scoring insert, wherein the scoring insert is affixed to the core insert.

23. The form for manufacturing the hollow block of claim 22, wherein the scoring insert is affixed to the core insert by at least one magnet embedded within the scoring insert.

24. A form for manufacturing a coping cap comprising:
a plurality of doors, wherein each of the plurality of doors slide on rails and/or hinges attached to the coping cap form; and
a base comprising a plurality of texture molds configured for insertion of at least one removable insert into the form, wherein the removable insert is configured for imparting a shape to the coping cap.

25. The form for manufacturing the coping cap of claim 24, wherein each of the texture molds has a rubber mat configured for imparting a natural stone appearance on the coping cap.

26. The form for manufacturing the coping cap of claim 24, wherein the removable insert comprises a lifting insert including a removable cover.

27. The form for manufacturing the coping cap of claim 24, further comprising a plurality of clamps, wherein each of the clamps is positioned at about a 45 degree angle on each of the doors.
